(19) United States
(12) Patent Application Publication
(10) Pub. No.: US 2004/0113927 A1
(43) Pub. Date: Jun. 17, 2004

(54) Device and method for displaying text of an electronic document of a screen in real-time

(76) Inventors: Sandie Quinn, Falls Church, VA (US); Liavan Mallin, Washington, DC (US)

Correspondence Address: FAY KAPLUN & MARCIN, LLP, Suite 702, 150 Broadway, New York, NY, 10038, US

(21) Appl. No.: 10/317,232

(22) Filed: Dec. 11, 2002

(51) Int. Cl. G09G 5/00

(52) U.S. Cl. 345/700

(57) ABSTRACT

A system for displaying text of an electronic document comprises a display and a processor coupled to the display for forwarding the text to a screen for display one display unit at a time, at least a first portion of the display units consisting of one and only one word, wherein the processor determines whether an additional file is attached to the electronic document and displays a portion of the text corresponding to the attached file in a manner determined based on one of display characteristics, user input and system default values. A method for displaying text of an electronic document comprises the steps of forwarding to a screen text of an electronic document for display one display unit at a time wherein at least a first portion of the display units consists of one and only one word and determining whether an additional file is attached to the electronic document and displaying a portion of the text corresponding to the attached file in a manner determined based on one of display characteristics, user input and system default values.

### FIELD OF THE INVENTION

The present invention relates to a device and method for displaying text stored in an electronic document on a display screen for reading by a user in real time.

### BACKGROUND

The prevailing conventional method for displaying text on computer monitors or other electronic screens still replicates the central features of the more traditional form-print media (e.g., newspapers, books, etc.). The information from an electronic document is presented so that it resembles the conventional printed media, i.e., pages. Conforming the electronic screen to function as a printed page results in an inefficient use of the screen's capabilities.

In traditional print media, the storage media is the paper. The printer/producer or the author of the print media has complete control over the presentation of the text, i.e., legibility, size, color. Thus, each unique reader, the ultimate user, is confronted with the same unalterable characteristics, e.g., typeset, font size, page size, etc. Such characteristics cannot be optimized by the user to better suit his perrsonal preferences in order to make the experience of reading more comfortable, enjoyable, and comprehensible.

When the text is displayed electronically, such as, on a screen, the content is essentially separated from author's control. Thus the reader using the electronic document has some degree of control over the display of the text (e.g., user may change font size, page size, typeset, etc.), but there are some drawbacks to the conventional displays of the electronic text. First, the electronic screen displays the text with poor character contrast, making the text blurry and thus hard to read. Second, the proportions of an electronic screen differ from that of a regular printed page (i.e, the height of the screen is smaller than the width, while the height of the page is longer than the width), which makes it difficult to replicate the exact appearance of the page.

The problems are further exacerbated by the software used to display the text on the screen, which translates the electronic data and displays the text. The software uses either text-based or graphical user interface-based systems to present the text. Both systems incorporate graphical aspects that involve various use of shading and colors to make the text appear as if it were on a printed page. The software also displays the text in such format so that the final product will be the paper version of the document being displayed.

The fundamental goal of reproducing quality paper versions of the text on the screen detracts from the higher standard in quality of the displayed text. Conventional display systems (e.g., word processors, spreadsheets and database management software) treat the electronically displayed text as an intermediate step, while emphasizing the final step of the process, the creation of the hard copy of the electronic document (e.g., printing the document). As the result of displaying the text in a printed page format on the screen, the user must sift through the pages by using a scrolling mechanism to access other pages or portions of the text.

The overall effect of the above described problems (i.e., scrolling and lower resolution) is that the average reading speed and comprehension of the individual when using the electronically displayed text will be slower. There will also be more physical energy expended by the reading in from the computer screen. Some of those effects include a rise in eye, neck and facial muscle tension and strain because the reader attempts to compensate for the poor presentation and legibility of the electronic document.

### SUMMARY OF THE INVENTION

The present invention is directed to a system for displaying text of an electronic document comprising a display and a processor coupled to the display for forwarding the text to a screen for display one display unit at a time, at least a first portion of the display units consisting of one and only one word, wherein the processor determines whether an additional file is attached to the electronic document and displays a portion of the text corresponding to the attached file in a manner determined based on one of display characteristics, user input and system default values.

The present invention is further directed to a method for displaying text of an electronic document comprising the steps of forwarding to a screen text of an electronic document for display one display unit at a time wherein at least a first portion of the display units consists of one and only one word and determining whether an additional file is attached to the electronic document and displaying a portion of the text corresponding to the attached file in a manner determined based on one of display characteristics, user input and system default values.

### BRIEF DESCRIPTION OF THE DRAWINGS

The accompanying drawings are included to provide a further understanding of the invention and are incorporated in and constitute part of the specification, illustrate several embodiments of the invention and, together with the description, serve to explain examples of the present invention. In the drawings:

FIG. 1 shows a schematic block diagram for a Brainspeed display device in accordance with the present invention;

FIG. 2 shows a schematic block diagram illustrating the preferred embodiment of the Brainspeed device of FIG. 1 in accordance with the present invention;

FIG. 3 shows an exemplary logic diagram for a method for translating the word on the server side in accordance with the present invention;

FIG. 4 shows an exemplary logic diagram for a method for translating the word on the client side in accordance with the present invention;

FIG. 5 shows an exemplary logic diagram for the preferred embodiment of the method in accordance with the present inventions;

FIG. 6 shows an exemplary embodiment of a method for displaying a display unit of an electronic document in accordance with the display unit-shifting process of the present invention;

FIG. 7 shows and exemplary embodiment of a method for displaying a display unit of an electronic document in accordance with the shading process of the present invention;

FIG. 8 shows an exemplary logic diagram for an exemplary embodiment of a method for displaying a display unit of an electronic document on a color screen in a “banded” format in accordance with the present invention;

FIG. 9 shows an exemplary logic diagram for a display process method in accordance with the present invention;

FIGS. 10A and 10B show an exemplary logic diagram for a method for displaying the next display unit in an electronic document in accordance with the present invention;

FIG. 11 show an exemplary logic diagram for a method for calculating the starting position of the display unit in an electronic document in accordance with the present invention;

FIG. 12 show an exemplary logic diagram for a method for parsing the display unit word in an electronic document in accordance with the present invention;

FIG. 13 show an exemplary logic diagram for a method for user's input in accordance with the present invention;

FIG. 14 show an exemplary logic diagram for the preferred embodiment of a user preferences process in accordance with the present invention.

### DETAILED DESCRIPTION

The present invention is directed at a device for displaying electronic text in real time. Such devices (e.g., mobile phones, smartphones, or PDA's) may include an electronic screen that may be used to display text. They may also consist of an input device (i.e., keyboard or voice input).

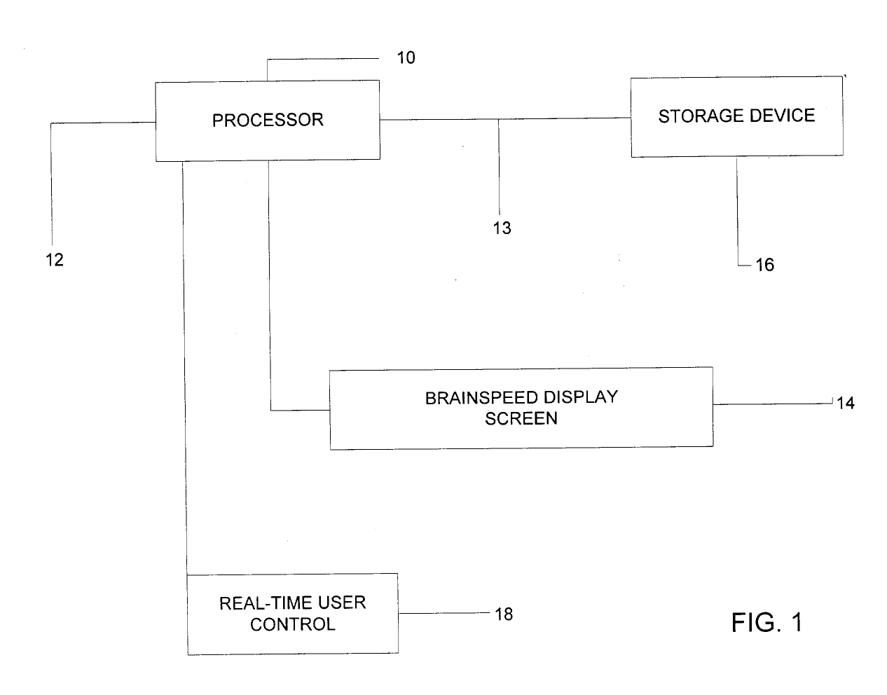

FIG. 1 shows a schematic block diagram of a Brainspeed display device 10. The Brainspeed device 10 includes a processor 12, a Brainspeed display screen 14, a storage device 16, and real-time user control 18. The user communicates with the Brainspeed device 10 through the user control 18. The user control 18 may be any device adapted for providing input to the Brainspeed device 10 (e.g., keyboard, touchpad, microphone/voice, etc.). The processor 12 includes an input 13 coupled to the storage device 16, which contains an electronic document that is to be read by the processor 12 and subsequently displayed on the screen 14. In accordance with the present invention, the screen 14 is adapted so that it can display text one display unit at a time wherein a display unit will usually include one and only one word. However, at times, a single display unit may include more than one short word. The screen 14 may be either color or black and white, it may also be capable of displaying various multi-media messages (e.g., graphs, pictures, movies, logos, advertising banners, drawings, presentations, etc.)

The processor 12 continuously controls the screen 14 so that the text of the electronic document is divided into a plurality of display units which are sequentially displayed so that the user can continuously read the document under real time control. Specifically, user control 18 allows the user to control the display or legibility characteristics of the text being displayed in real-time, without interrupting the display process 36. The changes in the characteristics are processed and are immediately incorporated by the processor 12, as discussed below.

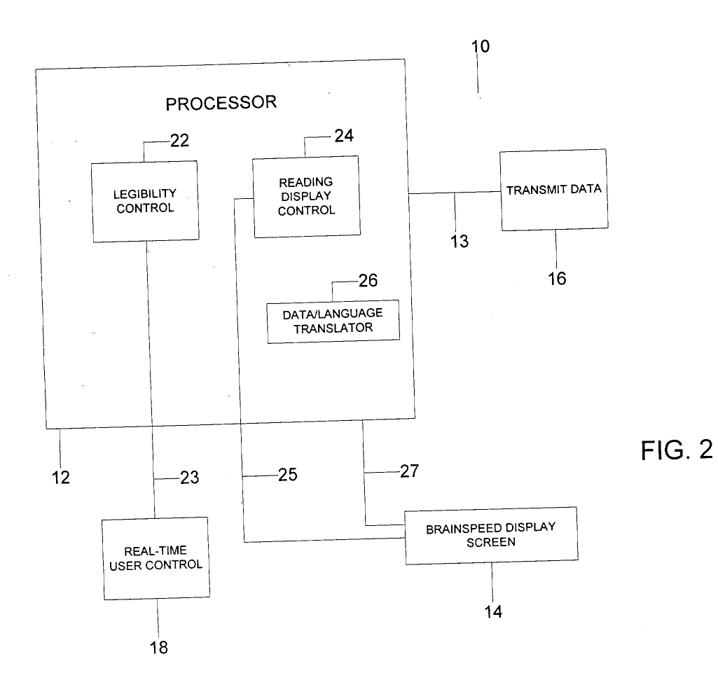

FIG. 2 shows a schematic block diagram illustrating a preferred embodiment of the Brainspeed device 10 of FIG. 1. In particular, processor 12 includes three logically separated control units 22, 24, 26 that allow the Brainspeed device 10 to display words and to alter the legibility characteristics simultaneously. A legibility control unit 22 controls legibility of the text and has an input 23 coupled to the user control 18 for receiving instructions from a user on desired legibility parameters to be discussed in more detail below. A reading/display control unit 24 controls the display of the text and has an input 13 coupled to the storage device 16 for receiving an electronic document to be displayed. Reading/display control unit 24 also has an output 25 coupled to the screen 14 for displaying the words of the electronic document. If the electronic document was encoded, a data/language translator unit 26 translates the information contained in the electronic document into words or multi-media format so that it may be displayed in a format that the user may understand. The data language translator unit 26 has an input 13 coupled to the storage device 16 for receiving an electronic document to be translated and an output 27 coupled to the screen 14 for displaying the words of the electronic document once they have been translated.

The electronic document that is to be displayed by the Brainspeed device 10 does not necessarily have to be stored in the storage device 16. It may be stored remotely on a server, (e.g., website server, e-mail server, another electronic device, etc.) and transmitted to the client, the Brainspeed device 10. The electronic document may be transmitted along a network or any other type of remote communications (i.e., wireless, LAN, Bluetooth, infrared, etc.). Since the access speed of a document located on a remote device is significantly slower than that of a document located locally (i.e., on the storage device 16) the size of the electronic document needs to be decreased.

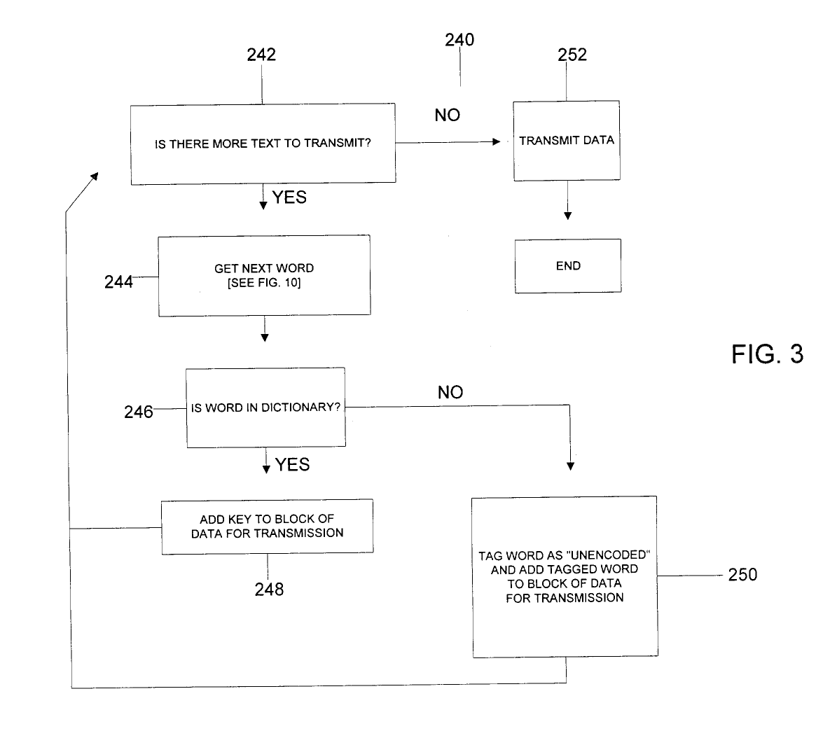

This may be accomplished by transmitting the document in an encoded form (e.g., compressed) and then translating the data prior to displaying the text on the Brainspeed device 10. FIG. 3 shows a method 240 which translates the words of the text on the server side before transmitting the text to the client. In step 242 the method 240 inquires whether there is more text to be transmitted (i.e., if the method 240 did not finishing traversing the block of text). If yes, then the method 240 proceeds to step 244.

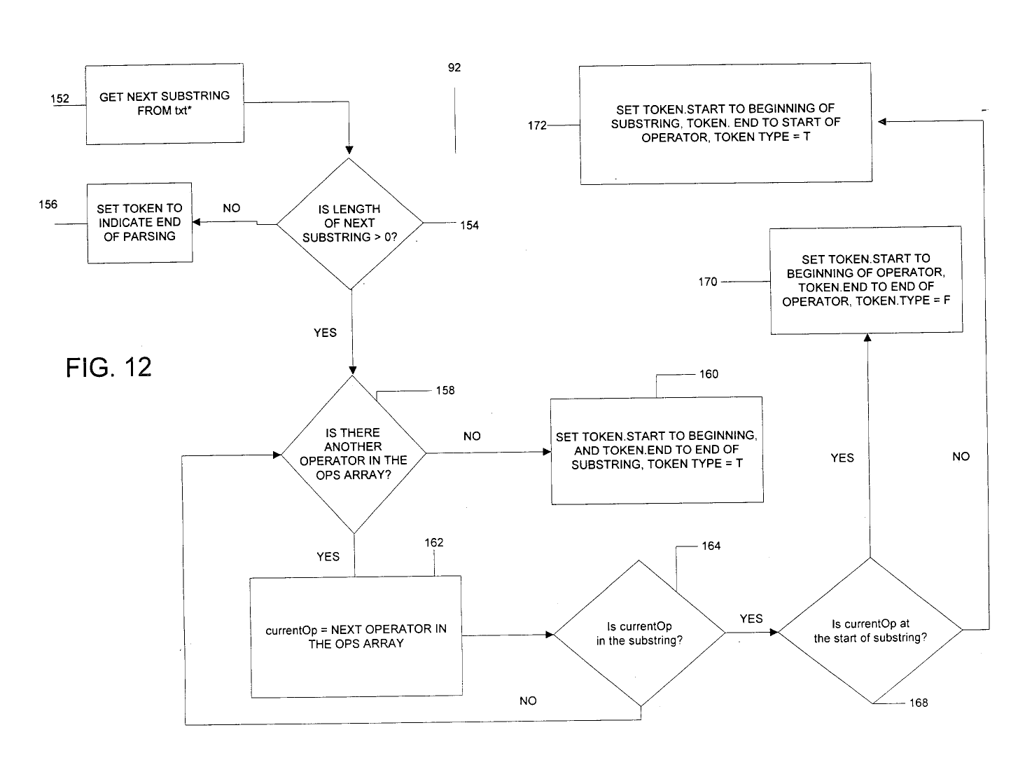

In step 244 the method 240 traverses through the electronic document in a substantially similar manner as done by the parsing method 92 shown in FIG. 12 and described below. After the method 240 reads a word it attempts to compress it. The compression mechanism is essentially a translation process, which converts words into designated keys. The process relies on the fact that most of the world's languages use a core lexicon which consists of only 3,000 words. The server would contain a translation dictionary, in which the words would be assigned a specific key (e.g., an integer value) which occupies significantly less data space than a word.

In step 246 the method 240 determines if the word obtained in step 244 is stored in the translation dictionary. If the word is found to be in the dictionary then the method 240 proceeds to step 248. In step 248 the key of the corresponding word is added to a block of data, which is the translation of the block of text. If the word is not found in the dictionary (e.g., the word is not part of the core lexicon) then the method 250 tags the word as “not encoded” and adds the word, without translating it, to the block of data. Thus the block of data may consist of both keys and not encoded words. Once the method 240 is finished with either the step 248 or 250 it reverts to step 242 in order to determine if another execution of the loop is necessary. If no, then the method 240 is finished encoding the text and in step 252 transmits the text to the client via a network.

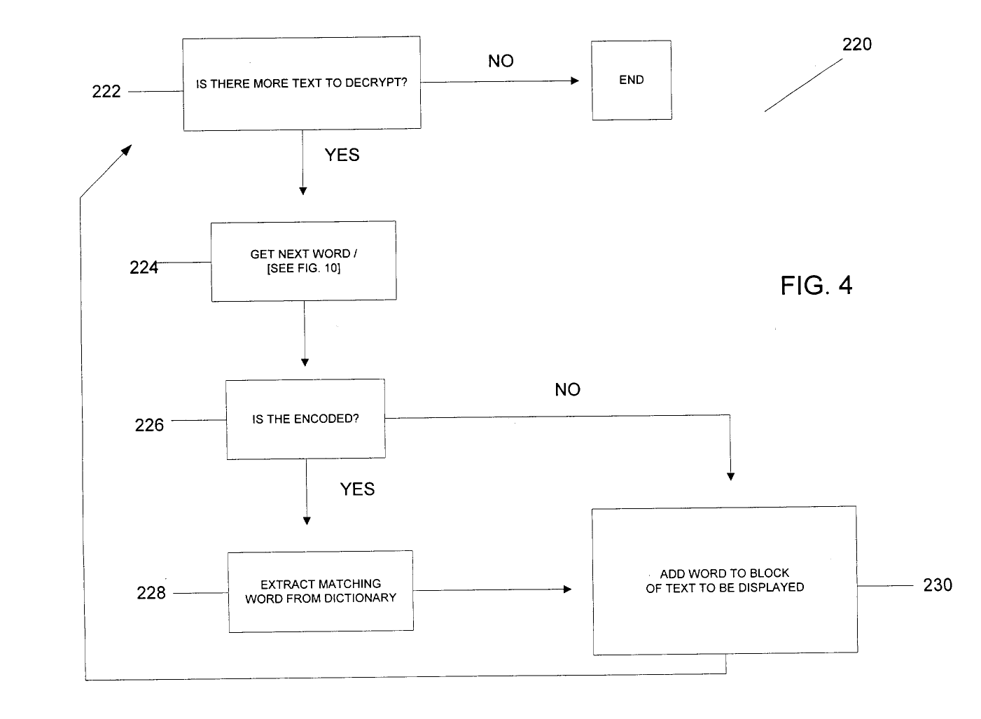

FIG. 4 shows a method 220 on the client side (e.g., Brainspeed device 10) for decoding/translating the data received from the server via method 220. After receiving the block of data the method 220 determines if there is more text to decrypt (i.e., the method 220 did no finish traversing the block of data). If yes, then the method 220 proceeds to step 224 in which the method 220 obtains the next segment in the block of data. The segment may either be a key or a word that could not be encoded by the method 240. The step 224 is substantially similar to step 244 and operates in a substantially similar manner to the text parsing method 92 shown in FIG. 12 and described below.

After the method 220 obtains the segment it must determine if the segment is either a key or word. If the segment is a key then the method 220 proceeds to step 228 in which it matches the key to the corresponding word. The client contains the same translation dictionary as the server so the client may translate the keys into corresponding words. In step 230, after the key is translated into the word, the word is added to the block of text. If the segment was a word that could not be encoded by the method 240 then in step 230 it is also added to the block of text. After the word is added to the text, then the method 220 returns to step 222 in order to determine if another execution of the loop is necessary. If no, then the method 220 is finished translating the text the block of text is ready to be displayed by the Brainspeed device 10.

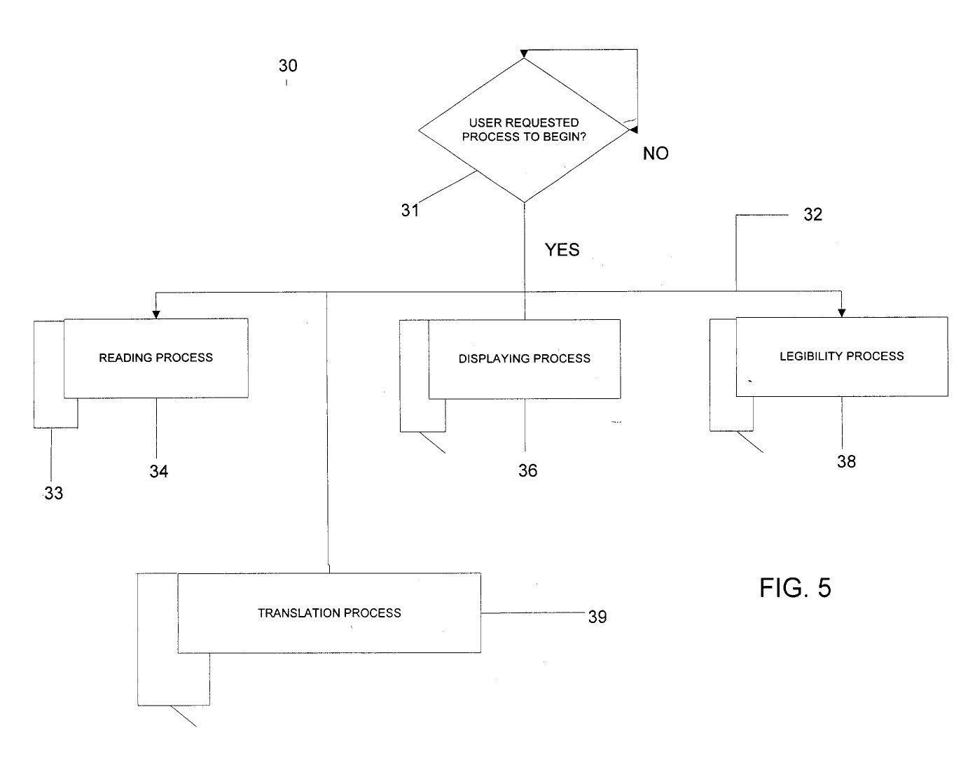

FIG. 5 is an exemplary logic diagram for the preferred embodiment of the method 30 of the present invention. The method 30 includes four processes 34, 36, 38, and 39 which simultaneously execute and control the display device of the present invention, in a parallel fashion. The method 30 begins at step 31 which determines whether or not the use has requested the processes to begin (i.e., the Brainspeed device 10 is in “sleep mode” and the user “re-awakens” it). The step 31 is awaiting a user input which can be in a variety of forms (e.g., if user control 18 is via a keyboard the user may press any key, if user control 18 is via voice the user may say “begin,” etc.). If there is no request from the user to begin the method repeats the step 31. If yes, the method simultaneously proceeds to processes 34, 36, 38 and 30 under a multi-threaded operation.

The reading process 34, the displaying process 36, the legibility process 38, and the translation process 39 are coupled through an inter-process communication 32 but are responsible for separate functions. The reading process 34 reads from the storage device 16 the relevant portions of the electronic document stored therein for subsequent display on the screen 14. While the screen 14 is activated for displaying, loop 33 of the reading process 34 guarantees that the device is reading the electronic document from the storage device 16, in real-time. Thus, any changes to the document by the other processes are accomplished without interruptions.

The displaying process 36 displays one display unit of the electronic document at a time. The displaying process 36 receives the display unit to be displayed from the reading process 34 via the inter-process communication 32 which links the reading process 34 and the displaying process 36. While the displaying process 36 is activated, loop 35 guarantees that the device is displaying the relevant word under the legibility characteristics chosen by the user via the user control 18.

The legibility process 38 monitors the user control 18 so that the user can alter the legibility characteristics of the displayed words in real-time. The legibility process 38 is responsible for controlling characteristics such as the font type, size, color, display speed and other characteristics. While the legibility process 38 is activated, loop 37 guarantees that the device is constantly updating the legibility characteristics. The legibility process 36 receives the legibility characteristics input from the displaying process 36 via inter-process communication 38 which links the reading the displaying process 36 and the legibility process 38.

The translation process 39 translates the words read from the storage device 16 by the reading process 34. As discussed above translation may be required if the document was transmitted to the Brainspeed device 10 from a remote device. While the translation process 39 is activated, loop 40 guarantees that the device is constantly translating the words as appropriate. The translation process 39 receives the words to be translated from the reading process 34 via inter-process communication 38 which links the reading the reading process 34 and the translation process 40.

In contrast to the conventional programming of processors using sequential processes, the method of the present invention uses processes which operate in parallel so that the display device can be efficiently controlled without the need for interruption in order to alter the legibility characteristics of the displayed text. As will be apparent to those of ordinary skill in the art, the reading process 34, the displaying process 36, the legibility process 38, and the translation process 39 can be implemented using a variety of programming languages (e.g., procedural languages, i.e, COBOL, C, C++, PASCAL, FORTRAN, etc., or declarative languages, i.e., PROLOG, LISP, and POPlog, etc.). The preferred programming language for implementing method 30 of the present invention is through a language which inherently provides backward chaining processes (e.g., repeat-fail loops) such as those provided in the PROLOG language.

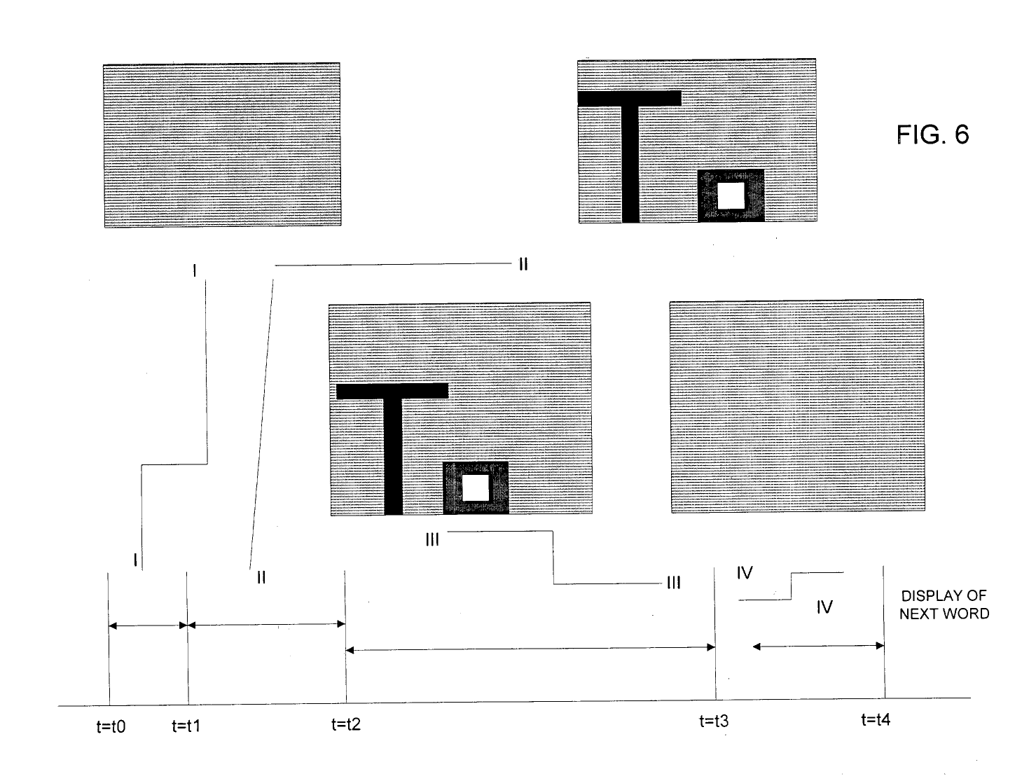

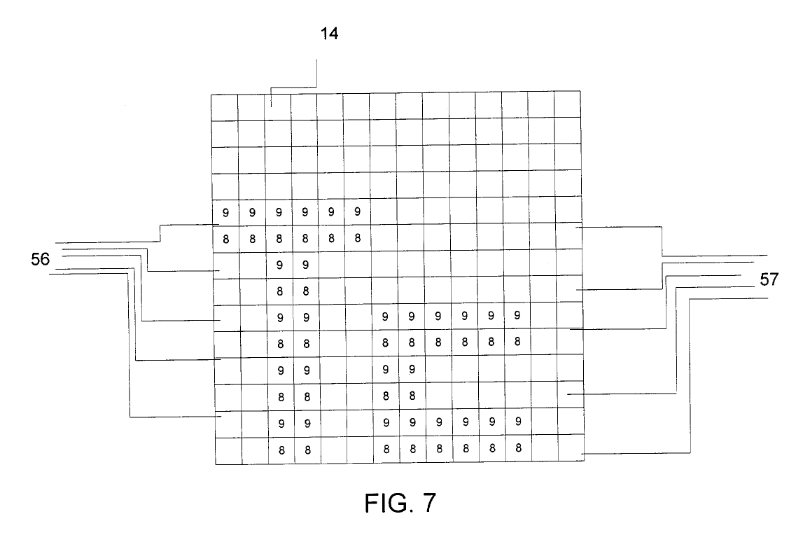

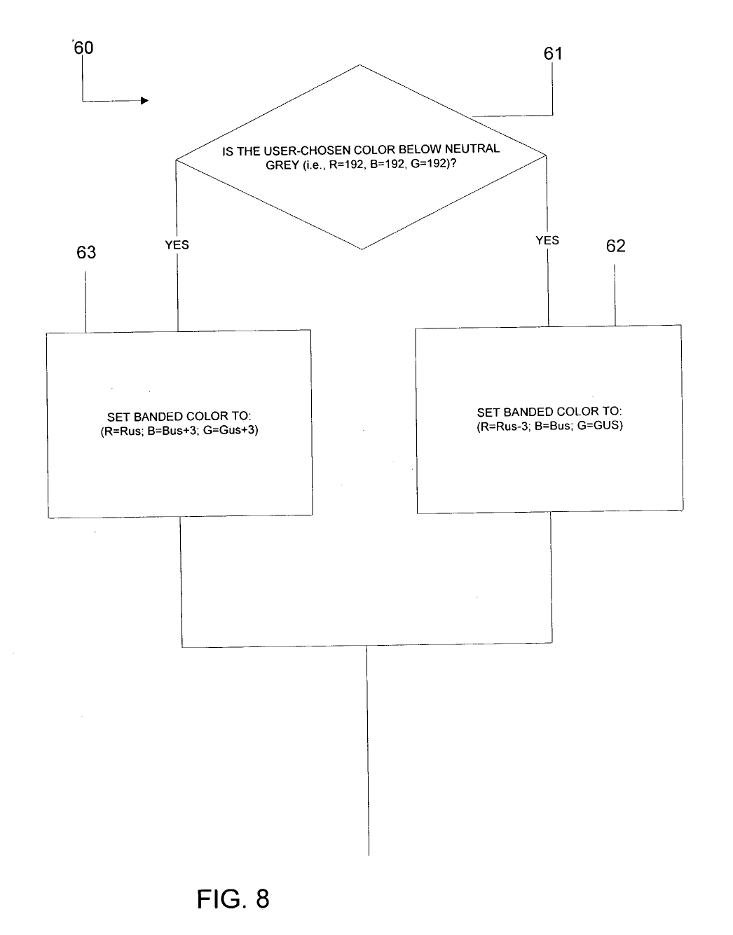

FIG. 6 is an exemplary illustration showing an embodiment of the method for displaying a single display unit of an electronic document on a screen in accordance with the present invention. Each individual display unit of the electronic document to be read and displayed on the screen 14 is preceded and followed by a brief period of a blank or clear screen as shown in periods I and IV of FIG. 8, respectively. Inclusion of these periods in the display process 36 will create an effect of flashing. In particular, for the time periods I and IV (between times t.sub.0 and t.sub.1 and t.sub3 and t.sub.4, respectively) the screen is cleared of any text. In between periods I and IV, a word to be displayed (e.g., “To”) is displayed in two separate and independent manners during periods II and III, respectively. In particular, for the time period II (between t.sub.2 and t.sub.3) the word “To” is displayed for the first time. Whereas during period III (between times t.sub.2 and t.sub 3) the word “To” is displayed the second time but it is shifted to the right a predetermined number of pixels (e.g., one pixel).

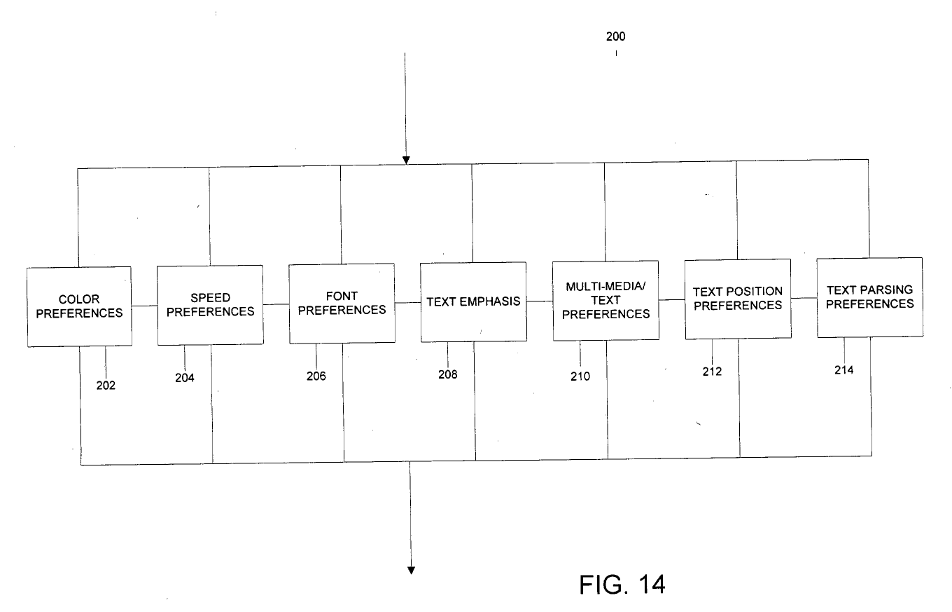

In accordance with the present invention, the shifting and flashing of the display unit a predetermined number of pixels during the time in which the display unit is displayed on the screen is believed to allow the user to read the electronic document faster with increased comprehension of the displayed text due to an increase of the impact of the displayed word(s) on the user's visual cortex. The length of period I is preferably chosen to be in the range from about 0.0001 seconds to about 0.005 seconds (i.e., the approximate length of the briefest periods achievable for refreshing the screens of conventional monitors). The length of period II is preferably chosen to be in the range from about 5 to 10 times the length of period I which corresponds to the range from about 0.0005 second to about 0.05 second. The length of period III is dictated by the user's selection of the overall word display speed. For example, for display speeds of 60 display units per minute to 3,000 per minute, period III would range from about slightly below 0.02 seconds to about slightly below 1 second, respectively. (The fact that the length of those periods would be “slightly below” those times is attributable to the fact that periods I and II must be added to period III to obtain the overall word display speed.). The length of periods I, II and III must be adjusted accordingly so that the overall desired display speed can be achieved in the speed preferences 204 shown in FIG. 14 and discussed below.

Although the amount of the shift of the word is illustrated in FIG. 6 is one pixel, other amounts of shift can be employed if desired (e.g., shifting in the range from about 1 to about 10 pixels). In addition, for languages that are read right to left the shift may be accomplished in the left direction. Also, for languages that read top to bottom, or bottom to top, the shift may be accomplished in the down or up direction, respectively. These changes may also be incorporated in the speed preferences 204.

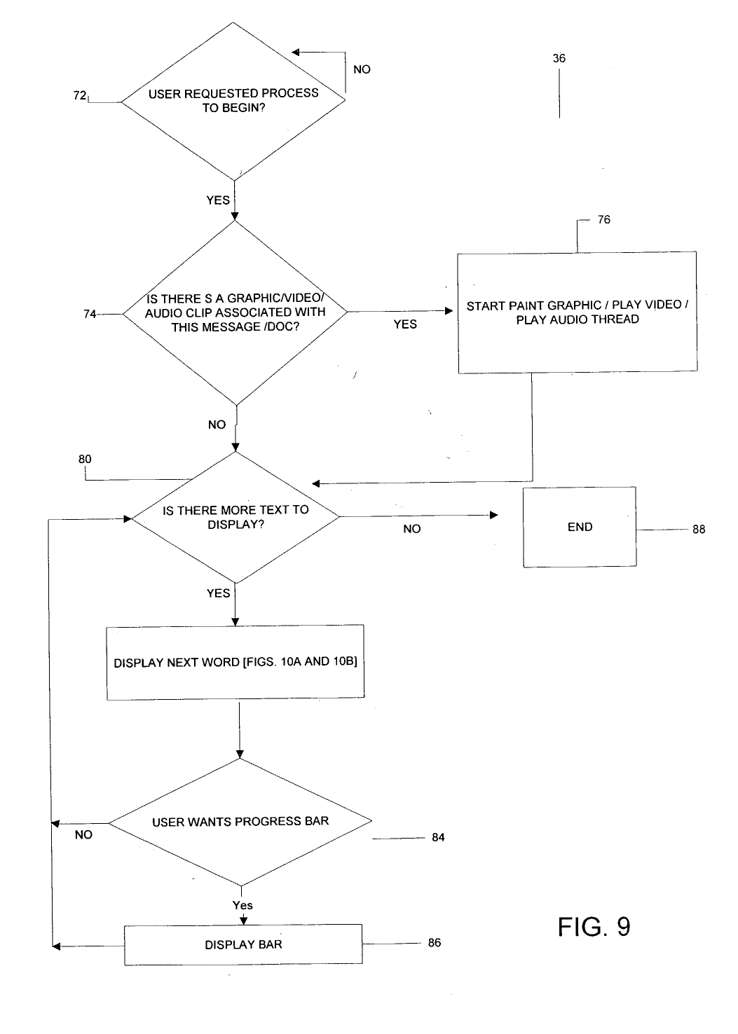

FIG. 9 is an illustration showing a second embodiment of the method for displaying a word of an electronic document in accordance with the present invention. As illustrated, screen 55 displays the word “To” within a 16 by 16 array of pixels. In accordance with this embodiment of the present invention, each pixel of the screen can be displayed with a different shading (or color) represented by a number between the range “0” and “9.” For example, “0” could represent a light shading (e.g., white), whereas “9” could represent a dark shading (e.g., black), with numbers in between that range representing various degrees of grey. As illustrated in FIG. 9, the word “To” is displayed with alternating bands of shadings represented by the values “9” and “8.” In particular, rows 56 of screen 55 are shaded with a shading having a value “9”, whereas rows 57 are shaded with a shading having a value “8.”

In accordance with the present invention, the use of bands of manipulated shading intensity is believed to allow the user to read the electronic document faster with increased comprehension of the displayed text due to an increase of the impact of the displayed word on the user's visual cortex. Preferably, the bands of shading are one pixel high for text (characters) read in a left to right or right to left manner, or one pixel wide for text (characters) read in a top to bottom or bottom to top manner. Thicker bands can be used if desired.

In accordance with the present invention, it is preferable that the “banding” process be employed with a color screen or monitor similar to those used in presentday desk- or lap-top computer systems. In particular, it is preferable that a monitor employing a RED, BLUE, GREEN color trivalence format having respective red, blue and green colors each capable of being able to take on color values in a range from “0” to “255.” If such a color monitor is employed, and the user selects one particular color for the display of the subject text, FIG. 8 is an exemplary flow diagram of a preferred embodiment of the method of the present invention for displaying the text in a “banded” format on such a screen.

Process 60 begins at step 61 where it is determined whether or not the color that the user has selected the text to be displayed in (R=R.sub.us; B=B.sub.us; G=G.sub.us) is below neutral grey. In other words, it determines if the color trivalence (R=R.sub.us; B=B.sub.us; G=G.sub.us) is below (R=192; B=192; G=192) for the exemplary “0” to “255” color schemes. If yes, the process proceeds to step 63 where the banded color is set to (R=R.sub.us; B=B.sub.us+3; G=G.sub.us+3) so that the blue and green color values are increased by 3 color units. If no, the process proceeds to step 62 where the banded color is set to (R=R.sub.us−3; B=B.sub.us; G=G.sub.us) so the red color value is decreased by 3 color units. In accordance with the present invention, this approach is used to harmonize the manipulated color shift in the bands with the color preference of the user. In particular, those users selecting a color generally below neutral grey (shading toward black), can be considered to be expressing a preference for blue-green and, accordingly, the color of the display in the banded areas is shifted towards that preference. Conversely, those users selecting a color generally above neutral grey, can be considered to be expressing a preference for the red end of the visible spectrum and, accordingly, the color of the display in the banded areas is shifted towards that particular preference. Although it is preferable to shift the color 3 units in one particular direction in the banded regions, other amounts of color shift could as well be employed.

Although FIGS. 5 and 6 illustrate only two of many possible variations of the shading or banding aspect of the present invention, if desired, other schemes for varying the intensity, color or shading of the displayed text can be employed. For example, instead of employing “bands” of intensity shading, one could just as well use other types of shading that cause the displayed characters to have the illusion of texture or variation in aspect (i.e., a variation in the overall look and feel).

In addition to shifting the displayed word a predetermined number of pixels (for example, one pixel to the right), and employing a banded shading pattern within the display, the present invention also includes a method for positioning a given word within the display in order to allow the user to modify the font size for easy and fast reading. In particular, the display device of the present invention is capable of maintaining a predetermined amount of “white” space above the displayed word so as to accommodate an adequate so-called “profile sweep” of the word during reading. Specifically, if a user desires to display a word in a font size that is too big for the chosen display window size, the method of the present invention positions the word so that the word is shifted down in the display (as opposed to up). This guarantees that a predetermined amount of “white” space will exist above the word so that with a profile sweep of the word during reading by the user, the word can still be typically recognized. This method is based on the assumption that it is the top portion of a character that is more important to recognition than the bottom portion. In other words, if a given portion of a character must be clipped in order to fit the character within the display, then it is preferable to clip the bottom portion (as opposed to top) of the character.

FIG. 9 shows an exemplary logic diagram for the displaying process 36 of the present invention. In step 72, the displaying process 36 inquires if the user requested to begin. If no, then the displaying process 36 continues with the same inquiry. If yes, the displaying process 36 proceeds to the next step 74. Step 72 is substantially similar to the one made in step 31. The step 72 may ask the user to provide some sort of input through the user control 18, i.e. the user has to press any key.

In step 74, the displaying process 36 inquires via the reading process 34 if there is a graphic, video, or an audio clip associated with the electronic document. The step 74 determines if the electronic document or the message contains a multi-media thread by looking through the entire file and alerts the displaying process 36 or its findings. If yes, then the method 70 proceeds to step 76. If no, then the process 70 proceeds to the next step 80.

In step 76, the displaying process 36 displays the graphic and/or plays the video or the audio thread. After the multi-media string is displayed the user may be prompted with an inquiry if he would like to replay it or continue with the displaying process 36. After step 76 is complete, i.e., the process 70 finished displaying a multi-media thread, the process 70 advances to step 80 as well.

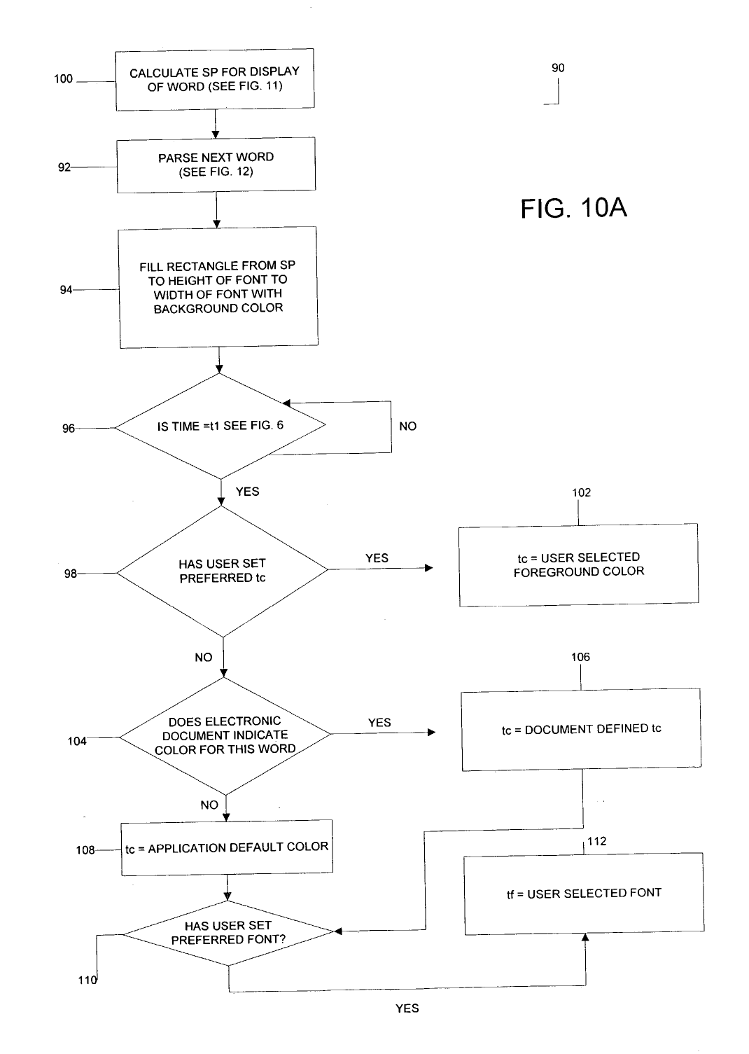

In step 80, the displaying process 36 inquires if there is more text to be displayed in the electronic document. This could be accomplished by analyzing the document and/or the file for such characters and flags that designate its end, e.g., EOF (end of file), EOL (end of line), etc. If the file and/or document is at its end and there is no more text to be displayed the displaying process 36 concludes at step 88, which is the end. If there is more text to be displayed then the process progress to the next step 84 and to the method 90 for displaying the next word, shown in FIGS. 10A and 10B and described in more detail below.

In step 84, the displaying process 36 determines wether the user has indicated that he would like for it to display the progress bar. The progress bar is a visual aid that would demonstrate how much of the text has been displayed and/or how much text there is still left to be displayed. As would be understood, the user may have previously been requested to indicate whether this progress bar should be displayed on the screen 14. If the user indicated that he wants the bar to be displayed, the displaying process 36 proceeds to step 86 and does so. If the user indicated that he does not wish for the bar to be displayed, then the process reverts back to the step 80, to determine if there is more text to be displayed.

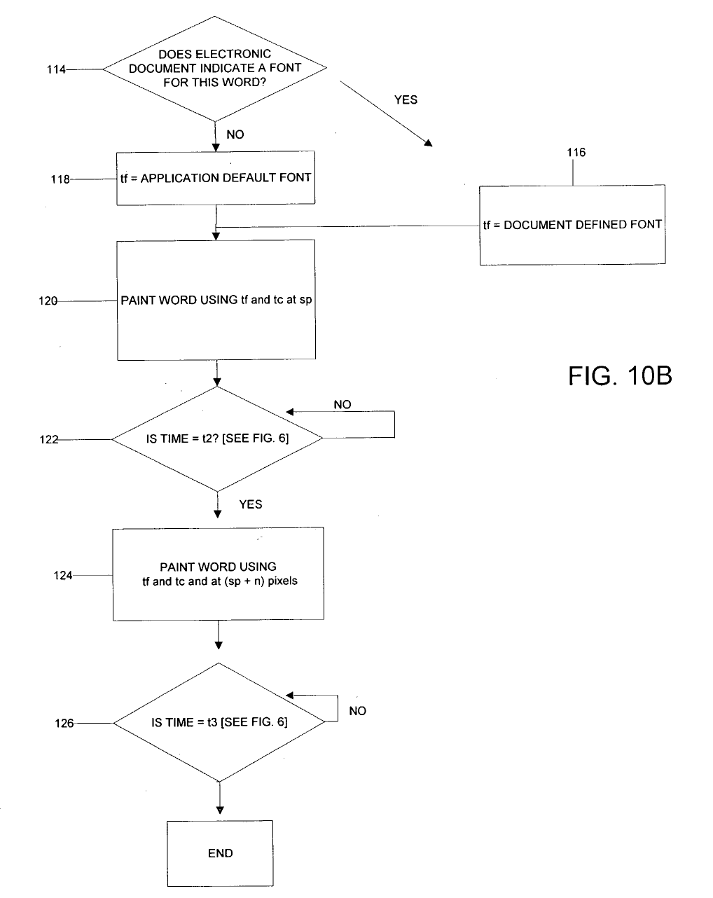

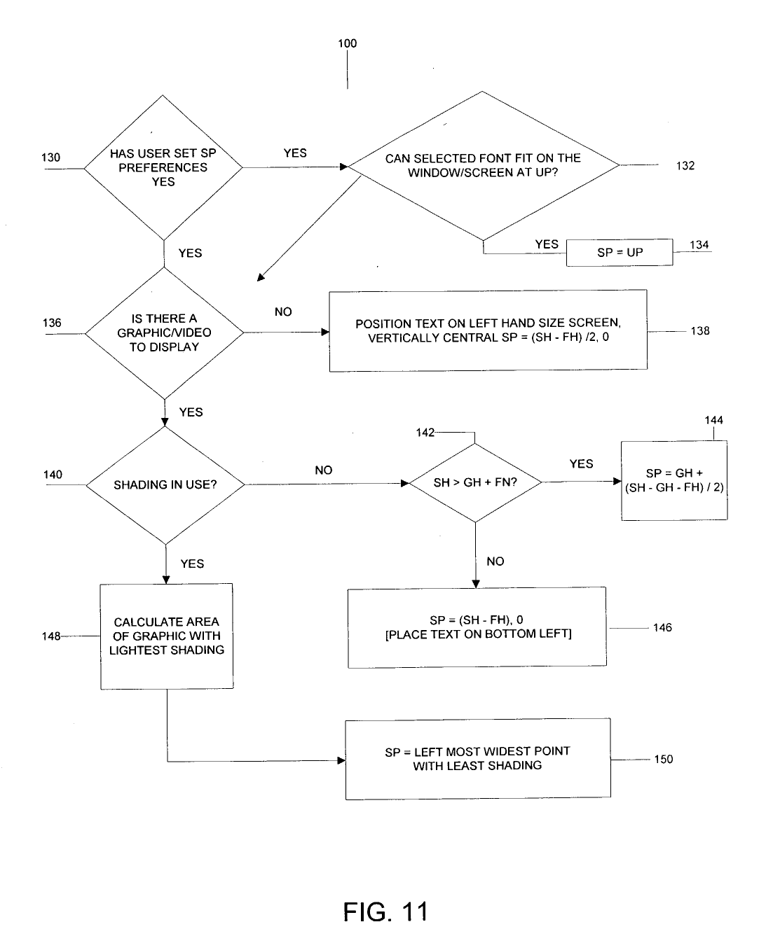

FIGS. 10A and 10B show an exemplary logic diagram for the method 90 for displaying the next word in accordance with the present invention. The first step, is a method 100 that calculates the start position (“SP”) of the word to be displayed. The method 100 is shown in FIG. 11 and is described in more detail below. In the next step is a text parsing method 92, which the method 90 utilizes to parse the next word. The parsing method 92 is shown in FIG. 12 and is described in more detail below.

In the next step 94, the method 90 draws a solid rectangle on the screen 14. The dimensions of the rectangle are based on the SP calculated in method 100, the height and width of the font, and the length of the display unit in characters. The corresponding space is then filled with the background color and it would provide the contrasting background upon which the display unit is displayed. The contrasting color background allows for better effect when the display unit is flashed on the screen 14.

The next step 96 is a test to determine if time is equal to t.sub.1. This test helps the method 90 to determine if the screen has been left blank for a predetermined Period I. If not, the method returns to step 96. T.sub.1 is shown in FIG. 8 and is described in more detail above. If yes, the method proceeds to step 98. In step 98, the method 90 makes determines if the user has set a preferred text color (“TC”). The text color could be selected from a variety of menus or other color selection palettes using the color agent ### as described in more detail below. If the user has set up a preferred TC then the method 90 proceeds to step 102, which assigns the TC the preferred value. If the user has not set up his preferred TC then the method 90 proceeds to step 104.

In step 104, the method 90 makes an inquiry whether the electronic document to be displayed indicates a specific TC for the display unit. If yes, then the method 90 progresses to step 106, in which it assign the TC a document-defined default TC value. The TC value may be contained within a variable that is attached to each word, or it may be attached to a particular segment of the document, so that all the words in that group are displayed in the same color. If not, then the method 90 proceeds to step 108, in which it assign the TC an application-defined default TC value. The application default TC value may be universal, i.e., applies to every word, or it may supply a different TC value for each segment of the electronic document. For example, a TC value may differ for the headings, chapter titles, quotes, footnotes, etc. from regular text messages, e.g., one type of words may be red, while the other, black.

After the TC color has been assigned, the method proceeds from the step 106 or 108 to a step 110. In step 110, the method 90 determines whether the user has set a preferred text font (“TF”). The text color could be selected from a variety of menus or other color selection devices using the font agent ### as described in more detail below. If the user has set up a preferred TF then the method 90 proceeds to step 112, which assigns the TF the preferred value. If the user has not set up his preferred TF then the method 90 proceeds to step 114.

In step 114, the method 90 makes an inquiry whether the electronic document to be displayed indicates a specific TF for the word. If yes, then the method 90 progresses to step 116, in which it assign the TF a document-defined default TF value. Similar to TC value, the TF value may be contained within a variable that is attached to each word, or it may be attached to a particular segment of the document, so that all the words in that group are displayed in the same color. If not, then the method 90 proceeds to step 118, in which it assign the TF an application-defined default TF value. Similarly, the application default TF value may be universal, i.e., applies to every word, or it may supply a different TF value for each segment of the electronic document. For example, a TF value may differ for the headings, chapter titles, quotes, footnotes, etc. from regular text messages, e.g, one type of words may be in bold, while the other may be in italics.

After the TF color has been assigned, the method then proceeds from the step 116 or 118 to step 120. In the step 120, the method 90 displays the word on the screen within the rectangle displayed in step 94. The method 90 uses the TC and TF values assigned in steps 98-118. The method 90 then progress to step 122, which is a test to determine if time is equal to t.sub.2. This test helps to determine if the word has been adequately displayed according to the predetermined Period II. If not, the method returns to step 122. T.sub.2 is shown in FIG. 8 and is described in more detail above. If yes, the method proceeds to step 126.

In step 124, the method 90, similar to step 120, displays the word using the designated TC and TF values, except now it offsets the word to the right a predetermined number of pixels as shown in FIG. 8 during Period III. The method 90 then progress to step 126, which is a test to determine if time is equal to t.sub.3. This test helps to determine if the word has been adequately displayed according to the predetermined Period II. If not, the method returns to step 122. If yes, the method 90 concludes.

FIG. 11 shows method 100 which defines and calculates SP. SP allows method 90 illustrated in FIGS. 10A and 10B to display and position the word on the screen 14, as well as the rectangular background upon which the word will be displayed. SP includes the coordinates, i.e., x and y in pixels, for the lower left corner of an imaginary rectangle within which the word will be displayed. The size of the rectangle, and hence SP will also depend on a variety of factors, i.e, the size and the resolution of the screen 14, the size of the font used, the size of the window displaying the text, the dimensions of a GUI run by the Brainspeed device 10, if any, etc.

In the first step 130, the method 100 uses a test to determine if the user has set up his SP preferences. The SP preferences would be set up using the text positioning preferences agent ### shown in FIG. 14 and described in more detail below. If there are user preferences then the method 100 proceeds to step 132. In that step the method 100 determines if the selected font can fit on the screen or the window at the user preferred start position (“UP”). UP is calculated using the size of the font, if UP is less then the width of the screen 14 or the display window, then UP fits. If UP fits then, SP variable is sent the same value as UP. Thus, technically, UP becomes the SP. If UP does not fit either then screen 14 or the display window, then the method 90 moves to next step 136.

In step 136, the method 100 makes a substantially similar inquiry as in step 74, wherein the displaying process 36 determined via the reading process 34 whether there was a multi-media thread, i.e., graphic, video, or an audio clip, etc. associated with the electronic document. If yes, then the method 100 proceeds to step 140. If no, then the process 100 proceeds to the next step 138.

Step 138 determines the SP for a display unit when there is no multi-media string to be displayed. The y-coordinate of SP is calculated as follows: the height of TF, font height (“FH”), is subtracted from the height in of the window or the screen 14, screen height (“SH”), both of the measurements are in pixels, and the result is divided by two. TF height is converted into pixels and that value is stored in a variable FH. The height of the window or the screen is also converted into pixels and that value is stored in SH. By subtracting the two variables, the height of the text, FH, from the height of the display area, SH, the method 100 obtains the height of the available free space. By dividing that value by 2 SP will be assigned the corresponding value and the method 100 will create margins of equal size that will be located above and below the text. The x-coordinate of SP is set to 0, placing the word to be displayed at the utmost left of the screen 14. This SP would vertically center the text in the middle of the screen 14 or the display window.

If there is a multi-media clip to be displayed the method 100 proceeds to step 140, in which the method 100 makes an inquiry whether the user chose to use shading in displaying the text or the graphic. The method 100 would make such an inquiry using the text emphasis agent ### described in further detail below and show in FIG. 14. If shading is not used then the method proceeds to step 142. If shading is in use then the method 100 progress to step 148.

In step 142 the method 100 performs a test. If SH is larger than the height of the graphic window (“GH”) in which the clip will be displayed and FH. If the combined height of the text, FH, and the height of GH, in pixels, is less than SH, then both the text and the multi-media clip may be displayed on the screen simultaneously, with the text being positioned right below the multi-media display window. In this instance, the method 100 proceeds to step 144. If those heights, GH and FH are larger than SH, then the multi-media clip and the text may not be displayed simultaneously on the screen 14 or a designated display window. In this instance, the method 100 progresses to step 146.

In step 144, the method 100 calculates the SP value, if both, the multi-media clip and the text can be displayed simultaneously. The SP is calculated as follows. First, the height of the multi-media clip, GH, and the text, FH, are subtracted from the height of the screen 14, SH. The result is then divided by 2 so that the margins for the text are the same on and bottom. The result of the division is then added to GH. Similar to the calculation in step 138, this procedure would essentially vertically center the text in the empty space below the multi-media clip window. If the screen 14 is not large enough to display the multi-media clip and the text simultaneously, then in step 146 the method 100 places the text in the bottom left corner in order to minimize the obstruction of the multi-media clip. SP is calculated in the following manner. The text height, FH is subtracted from the screen height SH. This positioning would not account for any margin space, since any available display space would be utilized by the multi-media clip.

If shading is in use then the method 100 progress to step 148, as described above. Shading is accomplished by calculating the area of the window in which the multi-media clip will be displayed. That area may in the shape of a rectangle or any other geometric figure (i.e., a rhombus, an oval, a circle, etc.). The shading effect is created by creating a duplicate of the window within which the multi-media clip is being displayed and offsetting it in any direction a few pixels (e.g., diagonally, longitudinally, latitudinally, etc.). The effect of the shade may be controlled by increasing the offset parameters and the color and brightness of the color used to paint the shade.

In an instance if shading is used SP of the text being displayed is assigned in step 150. SP is assigned a value such that it is the leftmost and widest point so that the text being in the position overlaps as little of the shaded area as possible. Various schemes and processes described above are used in method 100 to determine the best possible position for the text in order to clearly display the text contained within the electronic document. These processes address the issues that arise when the Brainspeed device 10 has to display multi-media clips or other advanced graphical accentuations, such as shading.

FIG. 12 shows method 92 which parses the next word from the electronic document so that it may be displayed on the screen 14. The parsing process extracts the word or a substring, which may be a single word or a collection of words, that are embedded in the code of the electronic document. In parsing method 152, the method 92 gets the next substring from the block of text according to the following process. The parsing method 152 utilizes a token to indicate the current processing position within the block of text (“TXT”). Each token may consist of three variables: the first variable token-start designates a starting position of the substring within the block of text; a second variable token-end designates an ending position within the block of text; and the last variable token-type designates a type of the token. Token-type may, for example, be an ‘S’ for a string token which is to be displayed, or an ‘O’ for an operator token which is not to be displayed. Depending on the value of token-type, the method 92 will make a determination whether to display or to omit a string from display. The method 92 will display all characters not designated in the operator (“OPS”) array, discussed in more detail below.

At the beginning of the parsing method 152, token-start and token-end are at the beginning of a new substring within the block of text. The substring consists by extracting the characters located between token-start and token-end. The method 152 evaluates the character to which the token-end is currently pointing, throughout the process the token-end is shifted to the next character so that the subsequent character may be analyzed, thus once the process is complete token-start is still positioned at the beginning of the substring and token-end is positioned at its end.

The analysis of characters consists of comparing them to the various types of characters and then performing the corresponding function (i.e., if it is a valid substring character, add it to the substring, if it is not, omit it, etc.). The characters may be of two types, one that is to be displayed (e.g., letters, numbers, symbols, etc.) or one that is to be omitted. An omitted character also known as a delimiting character, (i.e., a “” (space character)) is used to denote a word. Token-start is the position immediately following the first delimiting character. As the method 92 is shifting the token, it will add characters that are to be displayed to the substring. The shifting will continue until token-end encounters another delimiting character, at which point token-end will point to the previous valid character encountered. A that point the method 92 may calculate the number of characters contained within the substring by subtracting token-start from token-end.

In order to determine if the method 92 has parsed the entire document the method 92 performs a test in step 154 to determine if the length of the last substring was zero. An empty string may only be parsed if the method 92 has reached the end of the block of text. An empty string has zero characters, thus if the number of the characters in the string (the difference between token-start and token-end) is zero, then the string is empty and the parsing process is compete. If the parsing process is complete, in step 156, the token is set to a value representative of the end of the process. If the number of characters in the string is larger than zero, denoting that the parsing process is not yet finished, then the method 92 proceeds to the next step 158.

In step 158 an inquiry is made as to whether the operator array is exhausted. The OPS array consists of formatting operators (e.g., ““” (quote), “-” (hyphen), “/” (backslash), etc.) or punctuation devices (e.g., “.” (period), “,” (comma), “?” (question mark), etc.). Such characters will be stored in a special operator (“OPS”) array. These operators may be fixed by the application, but it may be possible for the user to extend or to limit the pre-defined set included in OPS array to include any punctuation devices. The OPS array includes any operators that the user does not want to be displayed. Although the block of text may contain such operators the method 92 will omit them. The method 92 would traverse the entire length of the string and determine if any of the characters within that string are defined in the OPS array. At the first execution of step 158 a variable current-op is assigned to the position of the first operator in OPS array. The process of analyzing the string for any operators involves, first assigning a value to current-op and then comparing current-op to each character in the string. If none of the characters of the string are operators (i.e., the method 92 compared each operator in OPS array to the string and found no matches) then the method 92 proceeds to step 160. In step 160 the method 92 assigns the values to the token variable. Token-start is assigned the position of the first character of the parsed string, token-end is assigned the position of the last character of the parsed string, and token-type is assigned “S” so that the method 92 will display the string.

If method 92 has not finished analyzing all of the operators, then current-op is assigned the next operator in the OPS array. In the next step 164, the method 92 compares each character (a set of characters if the current-op is more than one character long) in the string to current-op. If current-op does not appear in the string, then the method 92 reverts back to step 158 to determine if there are any operators remaining in OPS array that may be used to analyze the string. If an operator stored in current-op appears in the string then the method 92 proceeds to step 168.

In step 168, the method 92 makes an inquiry if current-op appears at the start of the string. Thus, if the first character is an operator the method 92 proceeds to step 170. In step 170, the method 92 parses the operator found in the string by assigning values to the token variable. Token-start is assigned the position at the beginning of the operator and token-end is assigned a position at the end of the operator, while token-type is assigned “O”, so that the method 92 will omit the string.

If step 168 determines that current-op is not at the start of the string (i.e., the operator is positioned in the middle or end of the string), then the method 92 proceeds to step 172. In step 172, the method 92 assigns values to the token variables. Token-start is assigned to the beginning of the string, token-end is assigned to the end of the string, and token-type is assigned “S” to display the portion of the substring up to the start of the operator.

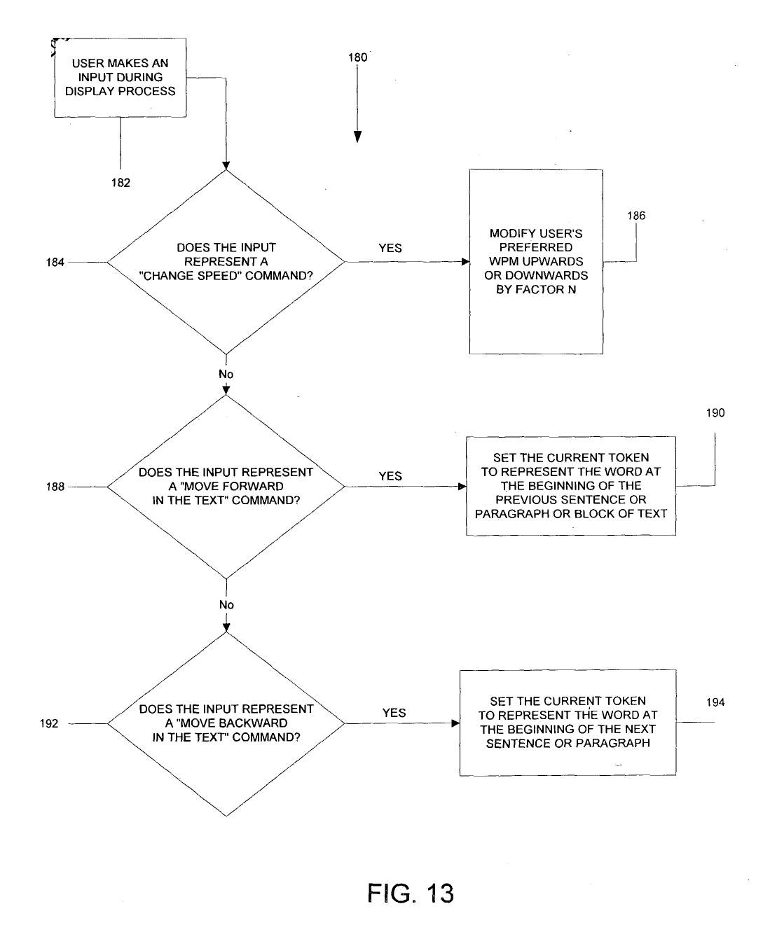

FIG. 13 shows a method 180 for navigation within a block of text. The method 180 describes how the user may influence the Brainspeed device 10 using a user control 18 while the displaying process 36 is running. In step 182, the user makes an input using the user control 18. The input may be a command to change the display speed, or a command to traverse in the block of text, either backward or forward.

The method 180 first determines if the input command is to change speed. The method 180 makes that inquiry in step 184. If the command is to change speed then the method 180 proceeds to step 186. In step 186 the display process 36 changes the display rate. The display rate may, for example, be measured in words (or display units) per minute and an input command to change the speed, either to increase or to decrease the display speed, is processed by incrementing or decrementing the number of words (or display units) displayed per minute.

If step 184 determines that a user-entered command does not represent a command to change speed, the method 180 proceeds to step 188. In step 188 the method 180 inquires whether the command entered by the user requires it to move forward through the text. If yes, the method 180 moves to step 190. The command to move forward through the text may skip a sentence, paragraph, or block of text, presently being displayed and proceed directly to the next such segment. As would be understood by those skilled in the art, the size, type, etc. of the segment traversed on receipt of the user command may be determined by the user in the preferences or determined based on the specific user input. If the user has not set a preference, a default value may be used, which may be any of the above-described segments of text or any other defined segment. The move forward command is accomplished by moving the token as shown in FIG. 12 and described above to the beginning of the next segment. If the token is already at the beginning of a new text segment, the command to move the text forward would move the token to the next segment of the text.

If step 188 determines that the command entered by the user is not to move forward through the text, then the method 180 proceeds to step 192. In step 192, the method 180 inquires whether the command entered by the user is to move backward through the text. If yes, then the method 180 proceeds to step 194. The command to move backward through the text is substantially similar to the move forward command. It also operates based on the preferences definition of a segment or the specific user input, etc. To move backward through the text, the method 180 moves the token as shown in FIG. 12 and described above to the beginning of the text segment presently being displayed. If the token is already at the beginning of the segment, the command may traverse the token to the previous segment. The method 180 may encompass other commands and list of inquiries that the method 180 makes can be indefinite.

In addition to the above-described processes of time shifting, shading and positioning (in the up and down direction) a given letter within the display, the present invention may also include a method for placing the displayed word either left or right-justified or centered within the display as desired by the user. It is believed that the left-justified method is the fastest and easiest mode for reading displayed text.

Accordingly, a device and method for displaying the text of an electronic document one display unit at a time using a low-cost processor for controlling the reading and displaying of the document has been described. In accordance with the preferred embodiment of the present invention, the device and method is implemented with a processor programmed in the PROLOG language or some other equivalent language.

FIG. 14 shows a method 200 for managing user defined preferences. For the preferred embodiment, a real-time software engine is employed within the PROLOG language. Specifically, intelligent process technology is used to create and maintain a multithreaded real-time state engine. The program is composed of several intelligent software processes each with a specific area of expertise. These processes are able to operate independently of all other processes. All of these processes also have access to a common database of operational parameters (i.e., the settings database).

These processes employ bidirectional inter-process communication to create and control the effect of the real-time display within the graphical user interface. The inter-process communication takes place between the specific event or service processes and a central state controlling process. For example, when the user wants to change the display speed, a speed preferences process 204 is manipulating the display process 38, while the other processes are still manipulating their respective areas of preferences.

The method 200 consists of the following processes, a color preferences process 202, a speed preferences process 204, a font preferences process 206, a text emphasis process 208, a multi-media/text preferences 210, a text position preferences process 212, and a text parsing preferences process 214. As discussed above, unlike in conventional so-called sequential processes, the present invention does not employ a single message processing loop waiting to react to a user's input in the form of key strokes or mouse movements. Rather this embodiment uses multiple threads of execution, each created during program initialization. These threads of execution are kept alive for the duration of the program by the mechanism of backtracking and the repeat predicate unique to process technology. The condition for termination of all of the processes is program closure. Each process can be considered to be a single threaded limited state machine.

These processes have the ability to accept user input through dialog windows. These windows are presented to the user and the user preferences are captured when the user accepts or otherwise closes the dialog window. The process in charge of the dialog monitors the dialog for the user's response or other changes. When these changes occur, the agent then takes the appropriate action based on its specific behavior database. These actions may include items connected to the program's function or appearance, but the majority of the information captured relates to legibility factors (e.g., color, speed of display, or typeface, etc.). This information may also include actions to take in response to the content being read by the program (i.e., display the multi-media thread).

These dialog processes each have the ability to hide or display the dialog window in response to user action. Each of the dialog-based process knows how to clear and populate its associated dialog window through a sampling of the settings database or their specific behavior predicates. Each of these processes also records any changes to the dialogs position on the screen. These changes are maintained in real time within the settings database.

The color process 202 is activated by a user-generated event from the program menu and it uses the database predicates for retracting and asserting the new value into the settings database and then uses the settings predicate to communicate color changes to the display process 38. The color changes involve the colors of the text being displayed, the background, the shading, and the multi-media thread. This process activates a dialog for communication with the user. As would be understood by those skilled in the art, depending on the capabilities of the device on which the software is installed, this dialog may capture the user's preferences for color through, for example, a selection from a predetermined palette, through custom color control via a series of slide bar controls, one for each of the color values for each the foreground and the background, or through any other method supported by the device. As with all of the processes in method 200 in accordance with the present invention, changes in the color are reflected in real time. Should the display be active at the time that a color change is made, the color of the display will change with each incremental update to any of the color slide controls or via the selection of a new palette. In fact, as would be understood by those skilled in the art, all of the graphic user interfaces described herein are simply examples which may be modified or replaced by any number of known substitutes to achieve the described functions. For example, display unit rate may be altered by a user depressing up and down arrow keys on a device which simply indicate that the speed is to be increased or decreased relative to the current speed without specifying or indicating what that current speed is.

The speed process 204 is activated by a user-generated event from the program menu and it uses the settings predicate to communicate the delay factor to the display process 38 and uses the database predicates for retracting and asserting the new value into the settings database. The current delay value represents the number of clock ticks to suspend the display of the current word. The speed process 204 allows for speeds as low as one display unit per minute and as fast as 3,000 words per minute. The 3,000 words per minute upper limit is the theoretical maximum speed of display assuming fast refresh rates on the display screen 14.

The speed process 204 captures the chosen number of words per minute from the speed control slide bar on the speed dialog. The user may choose to enter a words per minute number into the edit field on the dialog. This is linked to the speed control slide bar and keeps it constantly updated. As with all of the agents in accordance with the present invention, changes are reflected ip real time. Should the display be active at the time that a speed change is made, the speed of the display will change with each incremental update to the speed control slide bar.

The font process 206 is activated by a user-generated event from the program menu and it uses the settings predicate to set the typeface, font size, and position. The font process 206 captures the user's font preference in the font control dialog where the user selects the typeface desired from a listbox of fonts registered with and available to the underlying graphical user interface operating system. The size is set either through direct entry into an edit control or through selecting the size from a slide bar control.

The text emphasis process 208 is activated by a user-generated event from the program menu and it allows the user to choose if he would like the display process 38 to utilize the text emphasis included in the electronic document. The text emphasis process 206 captures the user's preferences in the text emphasis dialog where the user checks a corresponding box or option. If the user chooses not to utilize the text's emphasis then it will be omitted by the display process 38.

The multi-media preferences process 210 is activated by a user-generated event from the program menu and it uses the settings predicate to set to indicate if he would like to display the multi-media thread and the text simultaneously, or sequentially, and if sequentially, in which order. The multi-media process 210 captures the user's preferences in the multi-media dialog where the user check either of the two corresponding options, either sequentially or simultaneously. If the user has selected the option of displaying the text and the multi-media thread sequentially, then another dialog will require the user to enter the order in which the text should be displayed, either before or after the multi-media thread.

The text position preferences process 212 is directly related to the multi-media process 210 and its function depends on the user preferences in the multi-media process 210. For example, if the user has chosen to display the text and the multi-media thread sequentially, then the user does not need to communicate with the text position process 212. If the user has chosen to display the text and the multi-media thread simultaneously, then the text position preferences process 212 is activated by a user-generated event from the program menu. The user then inputs his preferences as to where the text should be displayed when there is a simultaneous display of text and multi-media threads.

The text parsing preferences process 214 is directly related to the text parsing method 92. The text parsing process 210 is activated by a user-generated event from the program menu and it indicates to the user if the user would like to manage the list of operators. The text parsing process 210 captures the user's preferences in the multi-media dialog where the user may opt to include or exclude certain operators. As described above, the text parsing method 92 utilizes operators to parse the text. The operators may be of a variety of types (e.g., operators that are stored in the operator array, which the method 92 does not display). In addition, certain operators may be used to signal to the method 92 that a specific action must be performed (e.g., “.” [a period] may be used to signal a longer pause before the next word or the next word may be displayed in a different color, etc.). The text parsing process 210 would allow the user to include or exclude operators so that the method 92 reacts accordingly to those changes.

It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A system for displaying text of an electronic document comprising:
a display; and
a processor coupled to the display for forwarding the text to a screen for display one display unit at a time, at least a first portion of the display units consisting of one and only one word, wherein the processor determines whether an additional file is attached to the electronic document and displays a portion of the text corresponding to the attached file in a manner determined based on one of display characteristics, user input and system default values.

2. The system according to claim 1, wherein, when an additional file attached to the electronic document is a multimedia file, the processor adds a height of the text (FH) to a height (GH) of a graphic window in which the multimedia file will be displayed to calculate a total height (TH) and, when TH is greater than a height of the display (SH), the multimedia file and corresponding text are displayed in one of a first simultaneous mode in which the text is overlayed on the multimedia file and a sequential mode in which the multimedia and corresponding text are displayed sequentially.

3. The system according to claim 2, wherein, when TH is less than SH, the multimedia file and corresponding text are displayed in one of a second simultaneous mode in which the multimedia file and corresponding text are displayed simultaneously in separate areas of the display, a third simultaneous mode in which the multimedia file and corresponding text are displayed simultaneously with the corresponding text overlayed on the multimedia file and the sequential mode.

4. The system according to claim 3, wherein the processor determines which mode in which to display multimedia files and corresponding text based on one of user preferences, system default values and data embedded in the electronic document.

5. The system according to claim 1, wherein the processor receives text in a first format and divides the text into a plurality of display units, wherein in the first format, a plurality of display units are displayed at the same time.

6. The system according to claim 5, wherein the processor utilizes a token to indicate a current position within an electronic document, the token including a first variable indicating a start position of a substring, a second variable indicating an end position of the substring and a third token indicating whether the string is to be displayed.

7. The system according to claim 6, wherein the processor identifies the start position and end position of a substring by locating a delimiting character, wherein, in a first mode, the processor creates a display unit from each portion of text located between adjacent delimiting characters and, in a second mode, the processor determines the length of a current substring between adjacent delimiting characters and a length of a second substring subsequent to the current substring and, when a total length of the current substring and the subsequent substring is less than a predetermined value, the processor combines the current and subsequent substrings into a single display unit.

8. The system according to claim 7, wherein the processor determines whether any characters in the current substring are included in a list of not-to-be-displayed operators and deletes any such characters from the current substring before forwarding the current substring to the display.

9. The system according to claim 8, wherein, when a not-to-be-displayed operator is removed from the current substring, the processor alters a display characteristic of the current display unit based on the particular not-to-be-displayed operator included in the current substring.

10. A method for displaying text of an electronic document comprising the steps of:
forwarding to a screen text of an electronic document for display one display unit at a time wherein at least a first portion of the display units consists of one and only one word; and
determining whether an additional file is attached to the electronic document and displaying a portion of the text corresponding to the attached file in a manner determined based on one of display characteristics, user input and system default values.

11. The method according to claim 10, further comprising the steps of:
adding, when an additional file attached to the electronic document is determined to be a multimedia file, a height of the text (FH) to a height (GH) of a graphic window in which the multimedia file will be displayed to calculate a total height (TH); and
displaying, when TH is greater than a height of the display (SH), the multimedia file and corresponding text in one of a first simultaneous mode in which the text is overlayed on the multimedia file and a sequential mode in which the multimedia and corresponding text are displayed sequentially.

12. The method according to claim 11, wherein, when TH is less than SH, the multimedia file and corresponding text are displayed in one of a second simultaneous mode in which the multimedia file and corresponding text are displayed simultaneously in separate areas of the display, a third simultaneous mode in which the multimedia file and corresponding text are displayed simultaneously with the corresponding text overlayed on the multimedia file and the sequential mode.

13. The method according to claim 12, further comprising the step of selecting the mode in which to display multimedia files and corresponding text based on one of user preferences, system default values and data embedded in the electronic document.

14. The method according to claim 10, further comprising the steps of:
receiving text in a first format; and
dividing the text into a plurality of display units, wherein in the first format, a plurality of display units are displayed at the same time.

15. The method according to claim 14, further comprising the step of utilizing a token to indicate a current position within an electronic document, the token including a first variable indicating a start position of a substring, a second variable indicating an end position of the substring and a third token indicating whether the string is to be displayed.

16. The method according to claim 15, further comprising the steps of:
identifying the start and end positions of a substring by locating a delimiting character, wherein, in a first mode, the processor creates a display unit from each substring located between adjacent delimiting characters which is to be displayed and, in a second mode, the processor determines the length of a current substring between adjacent delimiting characters and a length of a second substring subsequent to the current substring and, when a total length of the current substring and the subsequent substring is less than a predetermined value, the processor combines the current and subsequent substrings into a single display unit.

17. The method according to claim 16, further comprising the step of:
determining whether any characters in the current substring are included in a list of not-to-be-displayed operators; and
deleting any such characters from the current substring before forwarding the current substring to the display.

18. The method according to claim 17, further comprising the step of altering a display characteristic of the current display unit based on the particular not-to-be-displayed operator included in the current substring.
